(19) United States
(12) Patent Application Publication
(10) Pub. No.: US 2009/0038209 A1
(43) Pub. Date: Feb. 12, 2009

(54) Method of Biodiesel Production

(75) Inventors: Mohammed Farid, Auckland (NZ); Sam Behzadi, Auckland (NZ)

Correspondence Address: NIXON & VANDERHYE, PC, 901 NORTH GLEBE ROAD, 11TH FLOOR, ARLINGTON, VA, 22203, US

(73) Assignee: AUCKLAND UNISERVICES LIMITED, Auckland (NZ)

(21) Appl. No.: 12/084,148

(22) PCT Filed: Oct. 27, 2006
(86) PCT No.: PCT/NZ2006/000277

§ 371 Date: Jul. 16, 2008

(30) Foreign Application Priority Data
Oct. 27, 2005 (NZ) 543299

(51) Int. Cl. C10L 1/18; B01J 19/00

(52) U.S. Cl. 44/308; 422/211

(57) ABSTRACT

The invention relates to a process of producing biodiesel via transesterification reaction where the feed of vegetable oil and/or animal fat is atomised prior to the reaction. The process is suitable for continuous production of biodiesel.

### FIELD OF THE INVENTION

The present invention relates to a method of biodiesel production suitable for continuous production at near atmospheric pressure.

### BACKGROUND TO THE INVENTION

Biodiesel fuels have similar properties to those of diesel produced from conventional petrochemical processes. Biodiesel can be used directly to run existing diesel engines. The main advantages of using biodiesels are that they are renewable, biodegradable and require no engine modification. Biodiesels produce better quality exhaust gas emissions as they contain a negligible amount of sulphur, thus reducing the emissions of sulphur dioxide that are responsible for acid rain. If biodiesel could be manufactured at an affordable price it could play a major role in meeting energy needs.

There is a large potential for the future application of biodiesel in New Zealand industry for example. Since New Zealand is a major producer of animal fats, the potential for biodiesel production in this country is considerable. Currently in North America and Europe, several biodiesel plants have already been built.

Biodiesel preparation or alcohol esterification has been around since the 1940s.

In general, biodiesel production consists of three stages: feedstock refining, product processing (including reaction and possibly post reaction cleaning) and product distribution. Conventionally biodiesel is produced in a batch process using lower alcohols such as methanol and ethanol with animal fats or oils derived from vegetables. However, due to higher production costs, biodiesel has been overlooked as an alternative fuel for the future.

Biodiesel is produced through a transesterification reaction of triglyceride molecules present in fats and oils with alcohol, such as methanol. Transesterification is a stepwise reaction that breaks down triglyceride to form alcohol ester. The reaction stoichiometry requires a 3:1 molar ratio of alcohol to triglycerides to reach completion as indicated in Equation 1. In practice, a higher ratio is used to drive the equilibrium to the product side to achieve higher yields. Typically a molar ratio of 6:1 is used.

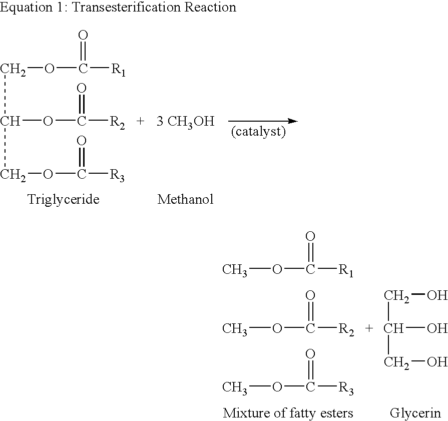

Over the years extensive research has been carried out to optimize this process. Previous work in this area has identified the following variables to have the greatest influence on the biodiesel reaction:
reaction temperature
ratio of alcohol to oil/fat
catalyst type and concentration
mixing
purity of reactants (% Free Fatty Acid, FFA)
type of alcohol

Based on the above variables a standard production method has been created that is followed by many manufacturers today. Typically the transesterification reaction is carried out at 60° C. and at atmospheric pressure. At this temperature, both reactants are in the liquid state. Attempts at using temperatures above 60° C. have been few. At these temperatures methanol starts to evaporate, lowering its concentration. This phenomenon occurs in low pressure batch reactors. However, this can be overcome by the use of high pressures. Several processes have used pressures of 9000 kPa and higher. At these pressures a reaction temperature of 200-300° C. can be achieved which is desirable but economically unfeasible.

Usually, biodiesel is manufactured in a batch process using an alkali catalyst. However, in recent years a greater emphasis has been placed on developing continuous processes that are able to use both low and high grade feedstock to reduce the overall production cost.

In general the reactor design and the catalyst used govern the quality of feedstock which can be used i.e. high or low grade. Both the batch and the continuous processes require high purity feedstock to minimize side reactions such as saponification. This is because the core reaction for both processes is the same (i.e. transesterification), however, the rate at which this reaction is carried out is different.

The use of high temperatures has been examined as a possible basis for a continuous process. WO 01/88072, describes a process that uses high temperatures as a means for producing biodiesel from vegetable oil in a continuous process. Use of temperatures above the boiling point of the alcohol gives rise to very high yields similar to that of the conventional base reactions in relatively short times. Methanol gas rather than liquid methanol is used under atmospheric pressure.

In GB 957679 the use of high temperatures to produce alcohol esters from a triglyceride source is also disclosed. Similarly to WO 01/88072, methanol gas at temperatures of 195° C. was introduced to a molten source of lauric acid. However, unlike WO 01/88072, this process operates under a vacuum to allow the product methyl ester and excess methanol to vaporise out of the system for collection and storage. This was achieved by keeping the reaction vessel under vacuum (i.e. 15-50 mm Hg) and at temperatures of 180-200° C.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### OBJECT OF THE INVENTION

It is an object of the present invention to provide an alternative route for biodiesel manufacture, and/or one which may be suitable for a continuous manufacturing process, and/or which at least provides the public with a useful choice.

### SUMMARY OF THE INVENTION

Broadly, in a first aspect of the invention there is provided a process for preparing alkyl ester via transesterification from a vegetable oil and/or meat fat containing triglycerides, comprising reacting an atomised feed of vegetable oil and/or meat fat (“the atomised feed”) with gaseous alcohol in a reaction vessel.

Preferably the process includes reacting the atomised feed with gaseous alcohol in the presence of an effective amount of a transesterification catalyst.

Preferably the process is conducted on a continuous basis.

Preferably the process includes carrying out the reaction at a temperature above the boiling point of the alcohol. Preferably at least 20-30° C. above the boiling point of the alcohol.

Preferably the process includes carrying out the reaction at around or slightly above atmospheric pressure.

Preferably the process includes preparing the atomised feed by passing the vegetable oil and/or meat fat through an atomiser, preferably on entry to the reaction vessel.

Preferably the process includes heating the vegetable oil and/or meat fat prior to atomisation.

Preferably the process includes reacting an atomised feed with gaseous alcohol present in a stoichiometric excess above 3:1 to triglyceride of the atomised feed.

Preferably the process includes mixing the liquid alcohol with the transesterification catalyst prior to reaction with the atomised feed, and preferably the mixture is heated to vaporise the alcohol and/or catalyst (and any reaction product formed between the alcohol and the catalyst) prior to reaction with the atomised feed.

Preferably the process includes recirculating the gaseous alcohol from the reaction vessel, through a condensing step, to an alcohol mixing vessel for mixing with the transesterification catalyst.

In one embodiment the process includes entry of the atomised feed and gaseous alcohol or alcohol-catalyst mixture into the reaction vessel through separate inlets, preferably in a counter current direction with respect to each other.

In an alternative embodiment the process includes entry of the atomised feed and gaseous alcohol or alcohol-catalyst mixture into the reaction vessel through via a coaxial flow inlet.

Preferably the vegetable oil and/or meat fat is subjected to a pre-atomisation purification step.

Preferably the vegetable oil and/or meat fat is subject to a pre-atomisation acid catalysed transesterification process. Additionally or alternatively the vegetable oil and/or meat fat is subjected to a pre-atomisation alkali refining process.

Preferably the alcohol is of the formula CₙH₂ₙ₊₁OH where n is from 1-5 with the atomised feed, more preferably the alcohol is method, preferably high grade.

Preferably the vegetable oil and/or meat fat is also high grade.

Preferably the transesterification catalyst is selected from H₂SO₄, HCl, NaOH and KOH and corresponding sodium and potassium alkoxides such as but not limited to sodium methoxide, sodium ethoxide, sodium propoxide and sodium butoxide.

Preferably the reaction vessel is a tubular reactor.

Preferably the reaction is carried out in a substantially water-free environment.

Preferably the process includes purifying one or more of the feed, alcohol and catalyst streams to remove water and/or other impurities detrimental to the reaction.

According to a second aspect of the invention there is provided a process for preparing alkyl ester via transesterification from a vegetable oil and/or meat fat containing triglycerides, comprising reacting in a reaction vessel an atomised feed of vegetable oil and/or meat fat containing triglycerides with an effective amount of vapourised sodium methoxide which has been prepared by the mixing and then vapourisation of methanol with sodium hydroxide in a mixing chamber prior to entry into the reaction vessel, and carrying out the reaction at a temperature greater than 80° C.

Preferably the process includes reacting an atomised feed of high grade vegetable oil and/or high grade meat fat containing triglycerides, preferably at around or slightly above atmospheric pressure.

Preferably the process is conducted on a continuous basis.

According to a further aspect of the invention there is provided a process for preparing alkyl ester via transesterification from a vegetable oil and/or meat fat containing triglycerides, comprising within a reaction vessel reacting a feed of vegetable oil and/or meat fat (the feed) with gaseous alcohol in the presence of an effective amount of a transesterification catalyst, wherein the surface area of the feed high enough that the reaction has >80% completion within 5 minutes of contact of the reactants.

Preferably the reaction has >80% completion within 2 minutes of contact of the reactants; more preferably within 30 seconds of contact of the reactants.

Preferably the process is conducted on a continuous basis.

Preferably the process includes reacting the feed with gaseous alcohol at least 20-30° C. above the boiling point of the alcohol.

Preferably the process includes reacting the feed with gaseous alcohol at around or slightly above atmospheric pressure.

Preferably the process includes reacting an atomised feed with gaseous alcohol present in a stoichiometric excess above 3:1 to triglyceride of the atomised feed.

Preferably the process includes increasing the surface area of the feed from that of a liquid phase feed by passing the vegetable oil and/or meat fat through an atomiser prior to reaction with the gaseous alcohol.

Preferably the vegetable oil and/or meat fat is heated prior to atomisation.

Preferably the process includes including mixing the liquid alcohol with the transesterification catalyst prior to reaction with the atomised feed and heating the mixture to vaporise the alcohol and/or catalyst (and any reaction product formed between the alcohol and the catalyst) prior to reaction with the atomised feed.

Preferably the vegetable oil and/or meat fat is subjected to a pre-atomisation purification step.

Preferably the alcohol is of the formula CₙH₂ₙ₊₁H where n is from 1-5, more preferably the alcohol is methanol.

Preferably one or both of the methanol and the feed is high grade.

Preferably the transesterification catalyst is selected from H₂SO₄, HCl, NaOH, KOH and corresponding sodium and potassium alkoxides such as but not limited to sodium methoxide, sodium ethoxide, sodium propoxide and sodium butoxide.

According to a further aspect of the invention there is provided alkyl ester prepared according to the abovementioned processes.

According to a further aspect of the invention there is provided a biodiesel suitable for use in a diesel engine wherein the biodiesel has been prepared at least in part according to one of the abovementioned processes.

Preferably the biodiesel comprises an alkyl ester prepared according to one of the processes of the invention mixed with petroleum diesel, preferably mixed in proportion with 5% to 20% petroleum diesel.

According to a further aspect of the invention there is provided a method for preparing biodiesel suitable for use in a diesel engine wherein the biodiesel contains alkyl ester at least some of which has been prepared according to a process of the invention.

Preferably the method includes a step of combining the alkyl ester prepared by the process of the invention with petroleum diesel.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification and claims means “consisting at least in part of”, that is to say when interpreting independent paragraphs including that term, the features prefaced by that term in each paragraph will need to be present but other features can also be present.

The term “vegetable oil” as used in this specification means oil extracted from plant sources. Vegetable oil contains saturated and unsaturated triglyceride molecules. The concentration of these components can vary depending on the type of plant and the type of refining process. Ideally the vegetable oil is pre-refined by the raw material supplier or by the biodiesel manufacturer.

The terms “meat fat” as used in this specification refers to fat obtained from animal sources including tallow (beef fat); ghee (butter fat); lard (pork fat); chicken fat; blubber and cod liver oil. It is composed predominantly of triglycerides. Ideally but not essentially the meat fat is pre-refined by the raw material supplier or by the biodiesel manufacturer.

By “high grade” with reference to the vegetable oil or meat fat we mean vegetable oil or meat fat with free fatty acid (FFA) content of <1.0% and low water content. Anything larger than that is considered “low grade”.

The term “biodiesel” as used in this, specification means an alkyl ester usually prepared via a transesterification process from vegetable oils or animal fats. Biodiesel is usually comprised of short chain alkyl esters such as methyl ester or ethyl ester or mixtures of these.

The term “atomisation” as used in this specification means the reduction of a material (such as of a fluid) to a fine spray or mist. This is often achieved by passing the particles through a nozzle. The term includes the process of nebulisation and other variants.

The term “atomiser” as used in this specification means an atomisation apparatus. Carburetors, airbrushes, misters, and spray bottles are only a few examples of atomisers. An atomiser could be high pressure, rotary, coaxial or others as known in the art.

The term “continuous process” as used in this specification means a process where the inputs and outputs flow generally continuously throughout the duration of the process. This is in comparison with a “batch process” in which generally a measured quantity of reactant may be added to the reaction vessel, the reaction is carried out, and the products are removed.

The term “reaction vessel” as used in this specification means any suitable vessel or reactor for conducting the transesterification process. This will be constructed from a material that is inert towards the reactants and catalyst that are being use. It will ideally have high strength to withstand high temperatures and pressures.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting

### BRIEF DESCRIPTION OF THE DRAWINGS

The invention will now be described by way of example only and with reference to the drawings in which:

FIG. 1: is a schematic flow diagram of a process of biodiesel production in accordance with the invention;

FIG. 2: illustrates one embodiment of plant set up appropriate to the process of the invention;

FIG. 3: illustrates the reactor component of FIG. 2;

FIG. 4: illustrates an alternative plant set up for the process of the invention.

FIG. 5: illustrates an alternative reactor component with coaxial nozzle.

### DETAILED DESCRIPTION OF THE INVENTION

The current invention uses the atomisation of the feed material (vegetable oil or animal fat) in an environment of alcohol which is preferably gaseous and generally in the presence of a catalyst in a reactor to bring about the transesterification process. The atomisation gives rise to an increase in contact surface area due to small droplets that are produced.

This invention is suitable for a continuous production process whereby the feed is continuously atomised and the methanol gas flows through the reactor in the direction against the current, or alternatively in the direction of the current. The process may be modified to suit a batch process as would be known by one skilled in the art, however its real benefit is to continuous processes.

In addition a higher reaction temperature can be used which increases the solubility of the reactants and reduces the mass transfer resistance. As a result the overall reaction kinetics is improved. Our temperature preference depends upon the alcohol used. We prefer to operate above the boiling point of the alcohol, as discussed below.

In a preferred form the excess methanol that is used for the reaction is continuously removed from the reactor as methanol vapour. This reduces post reactor cleaning and product separation which is a common requirement for batch processes.

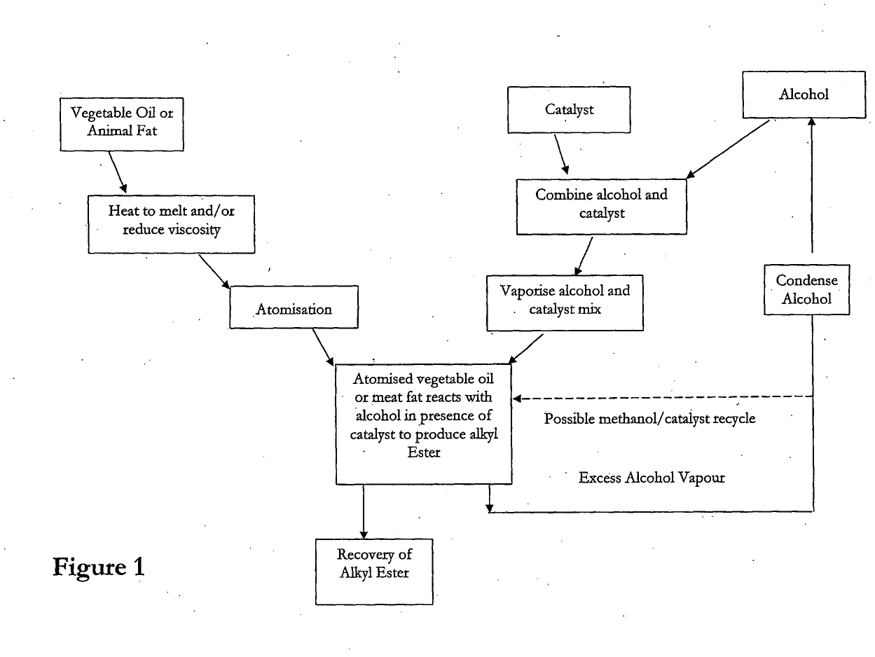

FIG. 1 illustrates via a flow diagram the preferred process of the invention.

FIG. 1 shows that in the preferred process the feed vegetable oil and/or animal fat is heated and then atomised. What is important is that the feed is in an atomised form, available to react inside the reactor. The step of atomisation can occur before or upon entry to the reactor. It can even occur directly after admission to the reactor. In the reactor, it reacts with the combined alcohol/catalyst mixture which ideally enters in the reactor in a pre-formed state, the mixture already having been heated to vapourise the mixture. As would be appreciated by one skilled in the art, it will be possible to use a liquid alcohol/catalyst mixture which is vapourised after entry to the reactor. It is also possible that the catalyst and alcohol are not pre-mixed. This is discussed below. Again with reference to FIG. 1, following the reaction of the feed with the alcohol in the presence of the catalyst, the alkyl ester is recovered on a continuous basis from the reactor whilst the excess alcohol vapour is taken off the reactor and is recycled via condensation and then re-mixing with fresh catalyst. It is also an option that it can be directly recycled back in to the reactor in order to maintain the pressure. A pressure slightly above atmospheric is preferred (as discussed below).

### The Reactor

At the simplest level, the reactor simply must be a contained reaction vessel which is kept free of water, with inlet and outlet connections to allow the reactants and products to flow through the reactor. The connection points will be determined by the required flow rates. A preferred reactor is a tubular reactor which is eventually pipe or tube based. The tubular design of the reactor is purely based on design and safety considerations.

### Alcohol

The preferred alcohol is methanol, predominantly as this is more widely available and cheaper. However, other short chain alcohols (CₙH₂ₙ₊₁ OH where n is from 1-5) are suitable. These alcohols must be as water free as possible, thus higher grade alcohols are preferred. However, lower grade or other alcohols which have a water impurity could be employed with a pre-step of drying or distilling. The stoichiometric requirement of alcohol to triglyceride for reaction according to a transesterification process is 3:1. However, we prefer to operate in excess of this ratio, up to 20:1. This excess assists in driving the reaction to completion and the methanol is recycled in our process and is not wasted.

### Feed Material

The typical biodiesel feed material is vegetable oil or meat fat. These are categorised into two sections, low and high grade. This is usually specified by the producer. For this process, feed material with free fatty acid (FFA) content of <1.0% is categorised as high grade while anything larger than that is considered low grade. In the preferred or simplest form, higher grade feeds (with FFA levels lower than 1.0%) are used directly into the process. If lower grade feeds are used then these could be handled in one of three ways. They could be used directly in the reaction process but with soap by-products being produced due to the saponification process which will occur under the reactor conditions. Alternatively lower grade feeds could be pre-treated via a pre-purification process of alkali refining. This requires treatment with an alkali source, such as sodium hydroxide or sodium carbonate. The purified triglyceride output is then fed into the reactor as the feed for the main reaction step. The final option involves carrying out an acid catalysed esterification step to convert the free fatty acid molecules present in the feed source into methyl esters and then feeding the remaining un-reacted triglyceride molecules through the described process for transesterification.

Our studies have been carried out for Soya bean oil and for beef tallow. It is well known in the art that triglycerides from vegetable oil and meat fat behave similarly. Further sources of mixed vegetable oil and fat can be used such as that obtained from waste cooking oil.

### Catalyst

Transesterification catalysts are known in the art. Preferred catalysts are metal hydroxides, such as NaOH or KOH, and corresponding sodium and potassium alkoxides such as sodium methoxide, sodium ethoxide, sodium propoxide and sodium butoxide. However, these are more suitable for high grade feeds. For lower grade feeds an acid catalyst such as HCl or H₂SO₄ is suitable. In our preferred process where high grade feed is used (as discussed above) then NaOH or KOH, more suitably NaOH, Will be used. However, if the feed is less pure an acid catalyst is used. In the scenario discussed above of a purification pre-step followed by the main reaction step, then an acid catalyst will be more suitable for the pre-step and the metal hydroxide catalyst for the main reaction.

It is preferred that the catalyst is mixed with the alcohol prior to entry into the reactor. This is easily achieved by combining the two into a tank, and mixing. They are then heated to a vapour together before entry into the reactor. Methanol and sodium hydroxide are mixed together in the preferred embodiment to produce a sodium methoxide complex. This complex functions as the actual catalyst species. Methanol and sodium methoxide boil at temperatures close to one another (methanol has a boiling point of 64.7° C. whilst that of sodium methoxide varies with concentration. At low concentration it is approximately the same as methanol e.g. 64.5° C. Thus they conveniently can be vapourised in the same heating step en route to the reactor. It is possible that the catalyst is not pre-mixed with the alcohol prior to entry into the reactor and is added separately. However it is likely that this will have a detrimental effect on the speed of the reaction, and though whilst included within the scope of the reaction, is not preferred.

No stoichiometric requirement of catalyst exists for the transesterification reaction. We prefer to operate at around 3 to 9 g NaOH/L methanol but are not restricted to this. The term “effective amount of transesterification catalyst” is accepted in the art to simply mean sufficient catalyst to ensure the reaction proceeds.

### Temperature

The operation temperature must be above the boiling point of the alcohol. The alcohols of interest and their boiling points are:

| | | |
|---|---|---|
| methanol | 64.7° C. | |
| ethanol | 78.4° C. | |
| propanol | propan-l-ol | 97.1° C. |
| | propan-1-ol | 82.3° C. |
| butanol | 117.73° C. | |
| pentanol | pentan-l-ol | 137.98° C. |

Our preferred operating temperature is generally of 20-25° C. above the boiling point, however, higher operating temperatures can be used to increase the reaction rate.

These reaction temperatures are higher than many of the prior art processes. These temperatures result in a higher reaction rate without the need to operate at high pressures. The transesterification process is controlled by both a mass transfer and a kinetic stage. By operating at a higher reaction temperature and using methanol vapour the kinetic barrier can be reduced allowing a shorter reaction time.

### Pressure

One of the benefits of the process of the invention is that the principal reaction can be carried out at atmospheric pressure. This is a distinct advantage simplifying reactor design.

This process requires less equipment such as mechanical agitators and distillation columns that are required for batch and some continuous processes operating at higher pressures.

In practice the actual pressure may be slightly above atmospheric due to the influx of gaseous methanol and atomised feed reagent into the reactor.

Higher pressures can be employed with higher temperatures, as mentioned above, but this will requite a suitable reactor able to withstand the harsher conditions.

### Atomisation

This is a key step in the process. The use of atomised feed material gives rise to increased contact surface area thereby assisting the reaction by decreasing the mass transfer resistance. The droplets in our experimental studies were produced using a diesel injection pump and nozzle. Any atomiser as known in the art would be suitable. The atomisation process also reduces or eliminates the need for mechanical mixing.

As will be understood by those skilled in the art, a certain viscosity of oil or fat will be required in order to make atomisation possible. Thus the oil or fat source will be heated to achieve that viscosity. The viscosity required will depend on the desired droplet size. We typically heat the feed to 100-130° C. Essentially any temperature up to the temperature of degradation of the feed can be used (which is for example, approximately 180° C. for vegetable oils). We have used in our studies droplet sizes of 50-150 microns, but any droplet size as would be appreciated by one skilled in the art could be used.

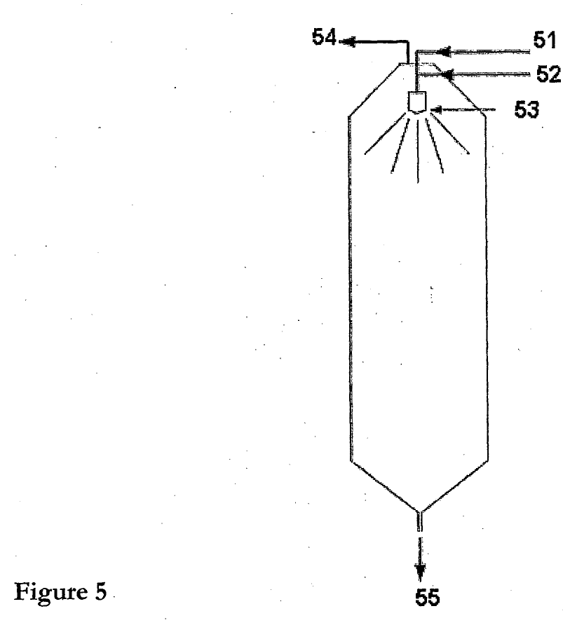

In the embodiment of the invention discussed herein the atomised feed inlet is separate to and in a counter current direction from the vaporised methanol inlet. However in an alternative embodiment a coaxial flow system could be used within the scope of the invention. This could be by way of a single inlet into the reactor through which both the methanol vapour and feed material enter. The methanol vapour would drive the atomisation of the fat (by breaking up the fat) so that the atomisation pressure required would be reduced. An alternative methanol heating process may be required to what is currently described. For this process methanol at higher pressures may be required than what is used in a counter current embodiment. Hence a small pressure vessel may be required to heat and pressurise the methanol vapour to what is required for atomisation (refer to FIG. 5).

### Pre-Steps

As discussed above, the feed oil or fat can be heated to achieve a desired viscosity prior to the atomisation step.

Furthermore the methanol and catalyst mix are preferably vaporised in a heating step prior to admission to the reactor.

As indicated above, in addition to the main reactor step if may be advantageous to include certain other pre-steps in the process. These may be pre-drying steps of the reagents (such as the alcohol), or pre-purification steps of the reagents (the alcohol, or the feed vegetable oil or fat—by esterification using an acid catalyst, or by alkali refining, for example).

Further, as mentioned above, in the case of a coaxial flow system, there may be a pre-step of pressurising the alcohol or alcohol/catalyst vapour before entry to the reactor.

### Other General Comments

It is important to minimise or ideally eliminate any water from the system. Water impurities will give rise to other chemical processes such as, when NaOH catalyst is used, causing sodium ions to attack the fat of the feed material. This reduces efficiency and causes other unwanted by-products.

In a preferred form, as illustrated in FIG. 1, there is continuous recirculation of methanol vapour through the reactor and out, to a condenser and then back to the methanol feed line. Since the methanol is in the vapour form it is possible to directly circulate the excess methanol back into the process. However, it may be necessary to continuously introduce a small quantity of methanol/catalyst to maintain a given concentration as the methanol/catalyst mixture is consumed by the reaction.

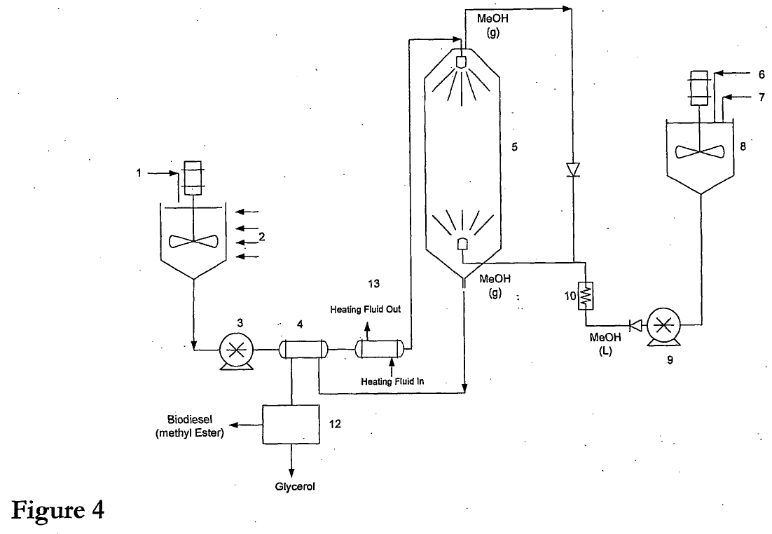

A further possibility which assists with energy recovery requires that the hot biodiesel product stream is used to preheat the feed oil/fat using the heat exchangers shown in FIG. 4 for example. However, additional heating may be required as this may not be sufficient to fully heat the stream to the required temperature.

A further possibility involves multi point feeding: i.e. introduction of the alcohol stream at several points within the reactor. This is to improve the contact rate of the reactants. Vegetable oil or animal fat may be atomised using multiple nozzles, depending the diameter of the reactor.

The use of a larger number of inlets may be advantageous in a larger set up. We also consider the residence time or time of reaction of our process. We have observed the reaction completes in a matter of seconds of contacting of the reagents.

There are a number of possible modifications and alterations to the process of the reaction and the plant associated with the process as would be appreciated by one skilled in the art. These modifications and alternations are included within the scope of the invention.

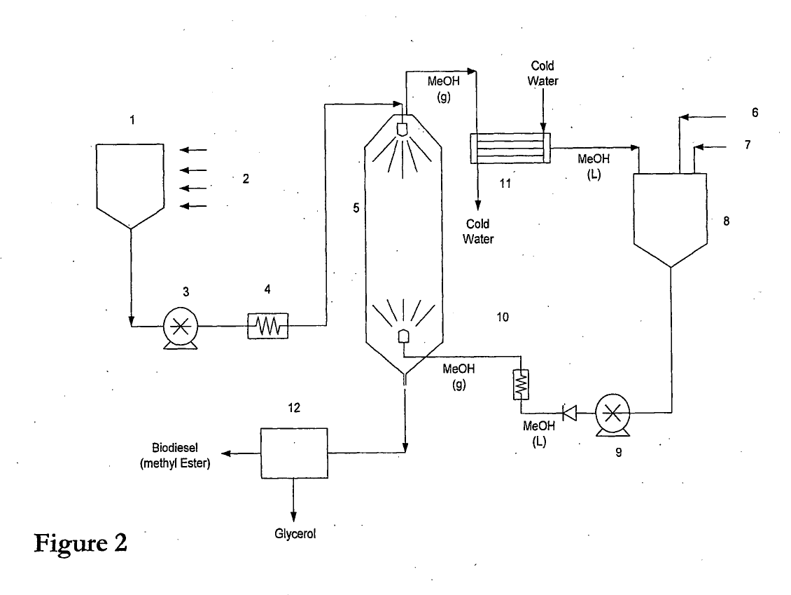

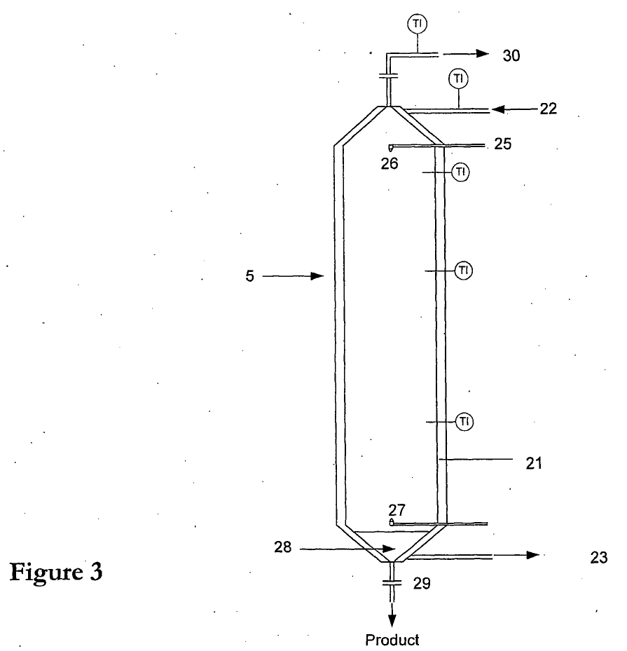

Preferred forms of the invention are now described with reference to the Figures. FIG. 2 illustrates an initial plant set up for one preferred embodiment of the invention. The feed meat fat or vegetable oil is held in a storage tank 1, which is heated by an external heat supply 2. It is transported via a high pressure pump 3 with further heating 4 to the reactor 5 through an atomisation nozzle (refer to FIG. 3).

The methanol 6 and the NaOH catalyst 7 are pre-mixed in a separate tank 8 and transported by a pump 9 as a liquid to a heat source such as an evaporator 10. The evaporator 10 heats the methanol to vapourise it Gaseous methanol/catalyst mixture is then admitted to the reactor 5. In the arrangement of FIG. 2 a counter-current direction from the fat or vegetable oil spray is illustrated. Also illustrated is the recycling of the gaseous methanol which is condensed at a condenser 11 and fed back to the methanol storage tank 8. The product of the transesterification process leaves the bottom of the reactor 5 and is transported to a separation unit 12 where the products form layers and can be separated. Where the feed fat or oil is relatively pure the products will be (as illustrated) glycerol and biodiesel (methyl ester). Alternatively when less pure feed the products will be soap, glycerol and biodiesel, as the impurities undergo a saponification reaction to form soap.

FIG. 3 illustrates the reactor 5 of FIG. 2 in greater detail. The reactor is heated, in this case with a heating jacket 21 fed with a heating fluid inlet 22, the heating fluid leaving at the outlet 23. The temperature is measured throughout the process as indicated by the temperature probes, T1. The feed material (tallow or vegetable oil) enters via the feed inlet 25 and through the feed atomisation nozzle 26 where atomisation takes place. The methanol enters in a counter current fashion at the alcohol inlet 27. A “liquid seal” 28 is in place to stop methanol vapour from escaping through the bottom of the reactor. This liquid seal is achieved by slowing the discharge rate of the reaction products from the reactor to which creates a back log of liquid and stops the flow of methanol from the bottom of the reactor using a level controller.

The product leaves the reactor 5 via the product outlet 29. Finally FIG. 3 also illustrates the methanol vapour outlet 30 at the top of the vessel allowing the methanol to be recycled.

FIG. 4 illustrates an alternative process in accordance with the invention. In this setup the main difference from that of FIG. 2 is that the outlet product stream is used to heat the incoming oil/fat stream. This allows recovery of some of the heat and cooling of the exiting product stream. It should be noted that the heat recovered may not be sufficient to reheat the incoming stream to the desired temperatures. Hence, additional heating (13, refer to FIG. 4) may be required to elevate the feed stream to the desired level. This setup is what would be practiced on a commercial scale where heat recovery is important. The excess methanol/catalyst mixture will be re-circulated back to the reactor together with fresh methanol/catalyst feed from feed tank 8.

An alternative embodiment employs a coaxial arrangement. In this setup high temperature/pressure methanol may be used to assist with the atomisation of the oil and fat. This will require a multi feed atomisation nozzle. This is illustrated in FIG. 5. Both the vegetable oil/meat fat (at 100° C.) (via, a first inlet 51) and the methanol/catalyst gas mix (via a second inlet 52) are fed to the coaxial flow injection nozzle 53. Excess methanol is discharged at an outlet 54 at the top of the vessel. The produced is discharged at an outlet 55 at the base of the vessel.

### ADVANTAGES OF PREFERRED EMBODIMENTS OF THE INVENTION

At least preferred embodiments of the process of the invention may have one or more of the following advantages:
The use of atmospheric pressure simplifying reactor design and reduce its capital and operating cost.
The use of elevated temperature improving kinetics and reaction rate.
Since the excess methanol is continuously removed from the reaction the need for post reaction cleaning is reduced. This simplifies the process and makes it more economically feasible.
There is a possible reduction in catalyst consumption. In batch processes the catalyst is used as a weight percentage of the oil or fat. This can range between 0.5-1 wt % of the feed material. It's possible to reduce this value even further with this process.
use of low-grade tallow or vegetable oil with high free Fatty Acids (FFA) For example it could be possible to process feed material with up to 5% FFA. Larger quantities of FFA may need to be removed or put through a purification process.
Shorter reaction time.
The process is suitable for a continuous process.

### EXPERIMENTAL

A gas reactor has been constructed, as illustrated in FIG. 2. Our experiments have examined the effect of feed atomisation, catalyst concentration and reaction temperature (in this case up to 20° C. above the alcohol's boiling point) on the transesterification reaction.

Our results show that this process can be operated in a continuous fashion with high consistency and a shorter reaction time than standard batch and continuous prior art processes.

Tables 1 and 2 present the results of a number of runs in the gas-liquid reactor system of the invention. Table 3 provides the details of the conditions and settings of these continuous runs. The input feed used in these runs was high grade Soya bean oil and beef tallow. Initially the feed oil or fat was heated to temperatures of 100-130° C. or higher. Heating was carried out in a stainless steel vessel with external heating supply. Once at the desired temperature the feed oil/fat was then pumped to the reaction tank where it was atomised. The flow rate of this stream was determined by the speed of the electric motor driving the pump e.g. 10, 15, 20, 25 Hz. Note as illustrated in FIG. 2 the feed stream was reheated after the pump 3 using a heat exchanger 4 to minimise the heat loss caused by the pump. In a separate stainless steel tank analytical grade methanol and NaOH were mixed together. This was to allow NaOH to dissolve in methanol and to form sodium methoxide which catalyses the reaction. This step was carried out simultaneously as the feed oil was being heated. Once the NaOH was completely dissolved in the feed methanol the mixture was pumped to the reaction tank. For these experiments a catalyst concentration of 3-9 g NaOH/L Methanol was used. As illustrated in FIG. 2 the methanol/catalyst mixture was passed through a coiled heat exchanger 10. This converted the liquid mixture into a gas phase. The vapour stream was then allowed to enter the reactor where it reacted with the atomised oil/fat droplets. The reactor temperature was kept at 75-90° C. using low pressure steam. However, alternative heating sources such as exhaust gases, high pressure steam and electric elements can also be used so that the reaction vessel could be operated at any temperature.

These experiments were carried out for periods of 15-30 minutes. During the experiment excess methanol from the system was collected by passing the vapours through a condenser. At end of each run the collected methanol was weighed to determine the amount that was consumed by the reaction.

At the completion of each experimental run the products were collected and allowed to settle into two layers i.e. glycerol and methyl ester. Once the products were separated into two layers the volume of each layer was measured. This was to determine the approximate conversion that had been achieved. Following that the density and the viscosity of the top layer was measured. This was carried out at the temperatures and conditions set down by the new Zealand Biodiesel Standard NZS7500-2005. Tables 1 and 2 presents viscosities and densities of the different experimental runs using beef tallow and Soya bean oil. The results obtained illustrated that the viscosities and densities of the products produced by this process meet NZS7500-2005 standard.

As will be clear from below, our results indicate that the process is similar in performance to a conventional batch reactor (see below discussions and Table 4 batch results) and also fall within the requirements of the New Zealand Biodiesel standards. The products from this process at all the different flow rates had similar properties (density and viscosity) to that of batch process using Soya bean oil and beef tallow. However, unlike conventional batch processes the current process provides a much shorter reaction time. Based on the results the current process is very capable of producing biodiesel continuously at a flow rate of 10 L/hr. The data collected illustrated that the flow rates tested had very little effect on the product quality and conversion. This indicates that the initial experiments were well with the maximum operating limits of the reactor and it is possible for the process to operate at higher flow rates. In addition, as previously mentioned, the process can be operated using beef tallow, vegetable oil or the combination of the two simultaneously (i.e. a mixed feed).

These tables show that the catalyst concentration within the range we studied did not affect the properties of the methyl ester produced.

TABLE 1
Fuel properties of Soya ester prepared from Soya
bean oil using the Method of the invention:

| Continuous Production | Soya Ester | | | | |
|---|---|---|---|---|---|
| Catalyst concentration (grams of NaOH/L MeOH) | 3 | 4.5 | 4.5 | 5 | 7 |
| Oil pump setting Hz) | 15 | 15 | 10 | 10 | 10 |
| Density (g/ml) | 0.8789 | 0.8873 | 0.8832 | 0.8907 | 0.8928 |
| Kinematic Viscosity | 4.21 | 5.41 | 5.32 | 6.28 | 7.17 |
| Viscosity (Pa · s) (this is an average viscosity) | 0.0037 | 0.0048 | 0.0047 | 0.0056 | 0.0064 |

Note,
viscosity was measured across a change of rpm from 100-500 @ 40° C.

TABLE 2
Fuel properties of tallow ester prepared from Beef Tallow using the Method of the invention:

| | Avg Operation | Catalyst Conc | | MeOH flow | Oil Flow | Total Oil | Total Product |
|---|---|---|---|---|---|---|---|
| Expt # | Time (min) | (g NaOH/L MeOH) | Oil type | (Dial Setting) | (Hz) | Pumped (L) | collected (L) |
| 1 | 18 | 6 | Tallow | 4 | 25 | 2.8 | 2.9 |
| 2 | 15 | 8 | Tallow | 4 | 25 | 2.3 | 2.35 |
| 3 | 15 | 10 | Tallow | 4 | 25 | 2.3 | 2.7 |
| 4 | 15 | 12 | Tallow | 4 | 25 | 2.3 | 2.4 |
| 5 | 15 | 14 | Tallow | 4 | 25 | 2.3 | 2.5 |
| 6 | 25 | 5 | Tallow | 4 | 25 | 3.8 | 4.3 |
| 7 | 25 | 6 | Tallow | 4 | 25 | 3.8 | 4.23 |
| 8 | 25 | 7 | Tallow | 4 | 25 | 3.8 | 4.28 |
| 9 | 25 | 8 | Tallow | 4 | 25 | 3.8 | 4.2 |
| 10 | 23.5 | 9 | Tallow | 4 | 25 | 3.6 | 3.6 |
| 11 | 23 | 5 | Tallow | 3 | 25 | 3.5 | 3.5 |
| 12 | 24 | 6 | Tallow | 3 | 25 | 3.7 | 3.8 |
| 13 | 22 | 7 | Tallow | 3 | 25 | 3.4 | 3.2 |
| 14 | 19 | 8 | Tallow | 3 | 25 | 2.9 | 3.4 |
| 15 | 27 | 9 | Tallow | 3 | 25 | 4.2 | 4.08 |
| 16 | 22 | 5 | Tallow | 4 | 20 | 3.4 | 2.99 |
| 17 | 25 | 6 | Tallow | 4 | 20 | 3.3 | 3.15 |
| 18 | 15 | 7 | Tallow | 4 | 20 | 2.0 | 2.25 |
| 19 | 18 | 8 | Tallow | 4 | 20 | 2.4 | 2.88 |
| 20 | 25 | 9 | Tallow | 4 | 20 | 3.3 | 3.7 |
| 21 | 23 | 5 | Tallow | 3 | 20 | 3.1 | 3.4 |
| 22 | 25 | 6 | Tallow | 3 | 20 | 3.3 | 3.89 |
| 23 | 25 | 7 | Tallow | 3 | 20 | 3.3 | 3.6 |
| 24 | 22 | 8 | Tallow | 3 | 20 | 2.9 | 3.5 |
| 25 | 27 | 9 | Tallow | 3 | 20 | 3.6 | 4.25 |
| 26 | 20 | 5 | Tallow | 4 | 15 | 2.3 | 2.8 |
| 27 | 19 | 6 | Tallow | 4 | 15 | 2.2 | 3 |
| 28 | 21 | 7 | Tallow | 4 | 15 | 2.4 | 2.75 |
| 29 | 25 | 8 | Tallow | 4 | 15 | 2.9 | 2.65 |
| 30 | 18.5 | 9 | Tallow | 4 | 15 | 2.1 | 2.25 |
| 31 | 29.5 | 5 | Tallow | 3 | 15 | 3.4 | 3.35 |
| 32 | 29 | 6 | Tallow | 3 | 15 | 3.3 | 3.5 |
| 33 | 26 | 7 | Tallow | 3 | 15 | 3.0 | 2.95 |
| 34 | 31 | 8 | Tallow | 3 | 15 | 3.6 | 4 |
| 35 | 25 | 9 | Tallow | 3 | 15 | 2.9 | 2.85 |

| | Total Bottom | Total Top | Approx | Density (avg) | Viscosity (avg) | Kinematic Viscosity |
|---|---|---|---|---|---|---|
| Expt # | layer (L) | Layer (L) | Conv (%) | (g/ml) | (Pa · s) | avg (mm²/s) |
| 1 | 0.4 | 2.5 | 90.3 | 0.885 | 0.00413 | 4.6658 |
| 2 | 0.35 | 2 | 86.7 | 0.874 | 0.00487 | 5.5705 |
| 3 | 0.65 | 2.05 | 88.8 | 0.873 | 0.00551 | 6.3149 |
| 4 | 0.44 | 1.96 | 84.9 | 0.869 | 0.00435 | 5.0022 |
| 5 | 0.45 | 2.05 | 88.6 | 0.869 | 0.00422 | 4.8526 |
| 6 | 0.62 | 3.68 | 95.7 | 0.868 | 0.00404 | 4.6528 |
| 7 | 0.77 | 3.46 | 90.0 | 0.870 | 0.00400 | 4.5941 |
| 8 | 0.8 | 3.48 | 90.5 | 0.870 | 0.00447 | 5.1421 |
| 9 | 0.78 | 3.42 | 88.9 | 0.867 | 0.00450 | 5.1941 |
| 10 | 0.6 | 3 | 83.0 | 0.865 | 0.00403 | 4.6601 |
| 11 | 0.57 | 2.93 | 82.8 | 0.877 | 0.00409 | 4.6699 |
| 12 | 0.7 | 3.1 | 84.0 | 0.876 | 0.00415 | 4.7420 |
| 13 | 0.55 | 2.65 | 78.3 | 0.868 | 0.00406 | 4.6742 |
| 14 | 0.65 | 2.75 | 94.1 | 0.867 | 0.00460 | 5.3084 |
| 15 | 0.68 | 3.4 | 81.9 | 0.873 | 0.00466 | 5.3394 |
| 16 | 0.46 | 2.53 | 74.8 | 0.871 | 0.00413 | 4.7433 |
| 17 | 0.57 | 2.58 | 77.4 | 0.867 | 0.00402 | 4.6312 |
| 18 | 0.48 | 1.77 | 88.5 | 0.868 | 0.00422 | 4.8576 |
| 19 | 0.625 | 2.255 | 94.0 | 0.869 | 0.00414 | 4.7618 |
| 20 | 0.92 | 2.78 | 83.4 | 0.869 | 0.00404 | 4.6537 |
| 21 | 0.78 | 2.62 | 85.4 | 0.867 | 0.00415 | 4.7813 |
| 22 | 0.75 | 3.14 | 94.2 | 0.871 | 0.00413 | 4.7433 |
| 23 | 0.66 | 2.94 | 88.2 | 0.867 | 0.00407 | 4.6979 |
| 24 | 0.8 | 2.7 | 92.0 | 0.868 | 0.00405 | 4.6684 |
| 25 | 0.75 | 3.5 | 97.2 | 0.869 | 0.00405 | 4.6640 |
| 26 | 0.75 | 2.05 | 89.1 | 0.869 | 0.00399 | 4.5970 |
| 27 | 0.95 | 2.05 | 93.8 | 0.869 | 0.00412 | 4.7400 |
| 28 | 0.78 | 1.97 | 81.6 | 0.872 | 0.00394 | 4.5189 |
| 29 | 0.9 | 1.75 | 82.4 | 0.870 | 0.00409 | 4.7051 |
| 30 | 1 | 1.25 | 90.7 | 0.873 | 0.00405 | 4.6466 |
| 31 | 0.8 | 2.55 | 94.7 | 0.868 | 0.00404 | 4.6528 |
| 32 | 0.8 | 2.7 | 96.9 | 0.870 | 0.00400 | 4.5941 |
| 33 | 0.85 | 2.1 | 91.7 | 0.875 | 0.00419 | 4.7905 |
| 34 | 1.1 | 2.9 | 91.6 | 0.877 | 0.00409 | 4.6699 |
| 35 | 0.8 | 2.05 | 82.8 | 0.876 | 0.00415 | 4.7420 |

With reference to the Tables:
1. Operation time excludes initial start-up and shut down time. (i.e. 5 min for start up and 2 min for shut down)
2. Most experiments are repeated a minimum of two times for accuracy and are only shown as averages in this table
3. Viscosity was recorded at 40° C.
4. Density was recorded at 20° C.

Viscosity was measured across a change of rpm from 100-500 @ 40° C.

TABLE 3
Conditions of the Continuous Reactor Runs

| | |
|---|---|
| Processing time (min) | 25-30 |
| Initial Reactor Temperature (° C.) | 93-95 |
| Reactor Temperature during experiment (° C.) | 75-90 |
| Steam Pressure supply to reactor | 5-10 psi |
| Methanol Feed Temperature (° C.) | 85-95 |
| Methanol Hot water bath Temperature (° C.) | 90 |
| Methanol Flow (ml/min) Dial setting 3 | 109.1 |
| Methanol Flow (ml/min) Dial setting 4 | 144 |
| Oil Flow ml/min @ 10 Hz | 90 |
| Oil Flow ml/min @ 15 Hz | 115 |
| Oil Flow ml/min @ 20 Hz | 133 |
| Oil Flow ml/min @ 25 Hz | 154 |

Table 4 is provided for comparative purposes. We conducted a number of runs using a batch process of biodiesel production. These experiments were carried out using high grade Soya bean oil and beef tallow. The experiment methodology was based on the norm practice described by most researchers in this field.

Initially a given quantity of oil or fat was weighed out and placed in a 500 ml glass reaction vessel equipped with a mechanical stirrer and baffle. The oil/fat was allowed to heat to the required temperature before the methanol/catalyst mixture was introduced. Using a 6:1 molar ratio the required amount of methanol was determined. For these experiments analytical grade methanol and NaOH was used. Similar to the continuous process NaOH was pre-dissolved into the methanol. This mixture was heated to the desired reaction temperature and was introduced into the oil/fat phase. These reactions were carried out for a period of 90 min.

After each experimental run the products were allowed to separate into layers. Following the separating process the volume of each layer was measured. The top layer was then water washed and neutralised to remove catalyst and excess methanol. In addition the density and viscosity of each layer was also measured. Refer to Table 4 and 5 for results and experimental conditions.

As will be evident from comparison of the Tables, the physical properties of the products of our continuous process of the invention and that of the batch process, typical of prior art processes, are in the same range.

TABLE 4
Batch Reactor Runs - Fuel properties of Soya and Tallow ester using batch reactor

| | Batch Production | | | | | | |
|---|---|---|---|---|---|---|---|
| | 100% | 0.4 wt % | 0.5 wt % | 0.6 wt % | 0.4 wt % | 0.5 wt % | 0.6 wt % |
| | Soya | Soya | Soya | Soya | Tallow | Tallow | Tallow |
| | bean oil | ester | ester | ester | ester | ester | ester |
| | — | Batch | Batch | Batch | Batch | Batch | Batch |
| Density (g/ml) | 0.9186 | 0.8800 | 0.8828 | 0.8780 | 0.8730 | 0.8690 | 0.8730 |
| Kinematic viscosity | 28.41 | 4.66 | 4.30 | 4.44 | 5.96 | 5.41 | 5.5 |
| (mm²/s) | | | | | | | |
| Viscosity (Pa · s) (this | 0.0261 | 0.0041 | 0.0038 | 0.0039 | 0.0052 | 0.0047 | 0.0048 |
| is an average | | | | | | | |
| viscosity) | | | | | | | |

Note,
viscosity was measured across a change of rpm from 100-500 @ 40° C.

TABLE 5
Conditions of the Batch Reactor Runs

| Processing time (min) | 90 |
|---|---|
| Initial Reactor Temperature (° C.) | 65 |
| Reactor Temperature during experiment (° C.) | 65 |
| Hot water bath Temperature (° C.) | 65 |
| Mole ratio (Methanol:Fat or Oil) | 6:1 |
| | Wt% (based on feed |
| Catalyst Concentration | oil/fat) |
| Weight of Fat or Oil (g) | 150-170 |
| Mixing (rpm) | 500 |

Finally Table 6 presents the New Zealand Biodiesel Standard NZS7500-2005 for acceptable density and kinematic viscosity. This standard is based on ASTM International standard (the most common standard referenced in the United States) for a number of feeds, again for comparison purposes. For these experiment the physical properties of the top layer was used as measure of quality and reaction conversion. Hence the standard created by ASTM was used as a guideline for our experimental measurements.

TABLE 6
excerpt of NZS7500-2005 Standards

| | | Limits | | Reference Test |
|---|---|---|---|---|
| Property | Unit | Min | Max | Method |
| Density at 15° C. | Kg/m³ | 860 | 900 | ASTM D4052 |
| | | | | ASTM D1298 |
| | | | | ISO 3675 |
| Viscosity at 40° C. | mm²/s | 2.00 | 6.00 | ASTM D445 |
| | | | | ISO3104 |

The results obtained from both the batch and the continuous process described in this report indicated that the biodiesel produced from them meet the NZS7500-2005 Standards. In addition it also illustrated that the current process produced biodiesel (alkyl ester) to the same quality as that of a batch process. However, this was achieved at a faster rate with less post reactor cleaning common to the batch process.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. A process for preparing alkyl ester via transesterification from a vegetable oil and/or meat fat containing triglycerides, comprising reacting an atomised feed of vegetable oil and/or meat fat (“the atomised feed”) with gaseous alcohol in a reaction vessel.

2. A process as claimed in claim 1 including reacting the atomised feed with gaseous alcohol in the presence of an effective amount of a transesterification catalyst.

3. A process as claimed in claim 2 including reacting the atomised feed with gaseous alcohol on a continuous basis.

4. A process as claimed in claim 3 including carrying out the reaction at a temperature above the boiling point of the alcohol.

5. A process as claimed in claim 4 including carrying out the reaction at least 20-30° C. above the boiling point of the alcohol.

6. A process as claimed in any one of the preceding claims including carrying out the reaction at around or slightly above atmospheric pressure.

7. A process as claimed in any one of the preceding claims including preparing the atomised feed by passing the vegetable oil and/or meat fat through an atomiser.

8. A process as claimed in claim 7 including passing the vegetable oil and/or meat fat through an atomiser on entry to the reaction vessel.

9. A process as claimed in any one of the preceding claims including heating the vegetable oil and/or meat fat prior to atomisation.

10. A process as claimed in claim 9 including reacting an atomised feed with gaseous alcohol present in a stoichiometric excess above 3:1 to triglyceride of the atomised feed.

11. A process as claimed in claim 9 or 10 including mixing the liquid alcohol with the transesterification catalyst prior to reaction with the atomised feed.

12. A process as claimed in claim 11 including heating of the mixture of liquid alcohol and transesterification catalyst to vaporise the alcohol and/or catalyst (and any reaction product formed between the alcohol and the catalyst) prior to reaction with the atomised feed.

13. A process as claimed in any one of the preceding claims including recirculating the gaseous alcohol from the reaction vessel, through a condensing step, to an alcohol mixing vessel for mixing with the transesterification catalyst.

14. A process as claimed in any one of the preceding claims including entry of the atomised feed and gaseous alcohol or alcohol-catalyst mixture into the reaction vessel through separate inlets.

15. A process as claimed in claim 14 including entry of the atomised feed and gaseous alcohol or alcohol-catalyst mixture into the reaction vessel through separate inlets in a counter current direction with respect to each other.

16. A process as claimed in any one of claims 1 to 13 including entry of the atomised feed and gaseous alcohol or alcohol-catalyst mixture into the reaction vessel through via a coaxial flow inlet.

17. A process as claimed in any one of the preceding claims including subjecting the vegetable oil and/or meat fat to a pre-atomisation purification step.

18. A process as claimed in claim 17 including subjecting the vegetable oil and/or meat fat to a pre-atomisation acid catalysed transesterification process.

19. A process as claimed in claim 17 or 18 including subjecting the vegetable oil and/or meat fat to a pre-atomisation alkali refining process.

20. A process as claimed in any one of the preceding claims including reacting an alcohol of the formula CₙH₂ₙ₊₁H where n is from 1-5 with the atomised feed.

21. A process as claimed in claim 20 including reacting methanol with the atomised feed.

22. A process as claimed claim 21 including reacting high grade methanol with the atomised feed.

23. A process as claimed in any one of the preceding claims including preparing the atomised feed from high grade vegetable oil and/or meat fat.

24. A process as claimed in any one of the preceding claims including carrying out the reaction in the presence of an transesterification catalyst selected from H₂SO₄, HCl NaOH and KOH and corresponding sodium and potassium alkoxides such as but not limited to sodium methoxide, sodium ethoxide, sodium propoxide and sodium butoxide.

25. A process as claimed in any one of the preceding claims wherein the reaction vessel is a tubular reactor.

26. A process as claimed in any one of the preceding claims including crying out the reaction in a substantially water-free environment.

27. A process as claimed in claim 26 including purifying one or more of the feed, alcohol and catalyst streams to remove water and/or other impurities detrimental to the reaction.

28. A process for preparing alkyl ester via transesterification from a vegetable oil and/or meat fat containing triglycerides, comprising reacting in a reaction vessel an atomised feed of vegetable oil and/or meat fat containing triglycerides with an effective amount of vapourised sodium methoxide which has been prepared by the mixing and then vapourisation of methanol with sodium hydroxide in a mixing chamber prior to entry into the reaction vessel, and carrying out the reaction at a temperature greater than 80° C.

29. A process as claimed in claim 28 including reacting an atomised feed of high grade vegetable oil and/or high grade meat fat containing triglycerides.

30. A process as claimed in claims 28 or 29 including carrying out the reaction at around or slightly above atmospheric pressure.

31. A process as claimed in claim 30 including reacting the atomised feed with an effective amount of vapourised sodium methoxide on a continuous basis.

32. A process for preparing alkyl ester via transesterification from a vegetable oil and/or meat fat containing triglycerides, comprising within a reaction vessel reacting a feed of vegetable oil and/or meat fat (the feed) with gaseous alcohol in the presence of an effective amount of a transesterification catalyst, wherein the feed has a surface area high enough that the reaction has >80% completion within 5 minutes of contact of the reactants.

33. A process as claimed in claim 32 wherein the reaction has >80% completion within 2 minutes of contact of the reactants.

34. A process as claimed in claim 33 wherein the reaction has >80% completion within 30 seconds of contact of the reactants.

35. A process as claimed in any one of claims 32 to 34 including reacting the feed with gaseous alcohol on a continuous basis.

36. A process as claimed in claim 35 including reacting the feed with gaseous alcohol at least 20-30° C. above the boiling point of the alcohol.

37. A process as claimed in claim 36 including reacting the feed with gaseous alcohol at around or slightly above atmospheric pressure.

38. A process as claimed in claim 37 including reacting an atomised feed with gaseous alcohol present in a stoichiometric excess above 3:1 to triglyceride of the atomised feed.

39. A process as claimed in any on of claims 32 to 38 including increasing the surface area of the feed from that of a liquid phase feed by passing the vegetable oil and/or meat fat through an atomiser prior to reaction with the gaseous alcohol.

40. A process as claimed in claim 39 including heating the vegetable oil and/or meat fat prior to atomisation.

41. A process as claimed in any one of claims 32 to 40 including mixing the liquid alcohol with the transesterification catalyst prior to reaction with the atomised feed and heating the mixture to vaporise the alcohol and/or catalyst (and any reaction product formed between the alcohol and the catalyst) prior to reaction with the atomised feed.

42. A process as claimed in claim 41 including subjecting the vegetable oil and/or meat fat to a pre-atomisation purification step.

43. A process as claimed in any one of claims 32 to 42 including reacting an alcohol of the formula CₙH₂ₙ₊₁OH where n is from 1-5 with the atomised feed.

44. A process as claimed in claim 43 including reacting methanol with the atomised feed.

45. A process as claimed claim 44 where one or both of the methanol and the feed is high grade.

46. A process as claimed in any one of claims 32 to 45 wherein the transesterification catalyst is selected from H₂SO₄, HCl, NaOH, KOH and corresponding sodium and potassium alkoxides such as but not limited to sodium methoxide, sodium ethoxide, sodium propoxide and sodium butoxide.

47. Alkyl ester prepared according to the process claimed in any one of claims 1 to 46.

48. A biodiesel suitable for use in a diesel engine wherein the biodiesel has been prepared at least in part according to a process claimed in any one of claims 1 to 46.

49. A biodiesel as claimed in claim 52 which includes an alkyl ester as claimed in claim 47 mixed with petroleum diesel.

50. A biodiesel as claimed in claim 49 wherein the alkyl ester is mixed in proportion with 5% to 20% petroleum diesel.

51. A method for preparing biodiesel suitable for use in a diesel engine wherein the biodiesel contains alkyl ester at least some of which has been prepared according to a process claimed in any one of claims 1 to 46.

52. A method as claimed in claim 51 including a step of combining the alkyl ester of claim 47 with petroleum diesel.

53. Apparatus adapted to prepare alkyl ester from vegetable oil and/or meat fat comprising a reaction vessel, an inlet for vegetable oil and/or meat fat, an atomiser associated with the inlet, the apparatus being adapted for a continuous process by including an inlet and outlet of gaseous alcohol or alcohol-catalyst mixture.

54. A method of preparing alkyl ester substantially as herein described and with reference to any one or more the accompanying figures.

55. A method of preparing alkyl ester substantially as herein described and with reference to any one or more the accompanying examples.
